(19) United States
(12) Patent Application Publication
(10) Pub. No.: US 2004/0216308 A1
(43) Pub. Date: Nov. 4, 2004

(54) Fruit scoop

(76) Inventor: Eugenia M. Bertulis, Seattle, WA (US)

Correspondence Address: Lawrence D. Graham, Attorney, Esq,, BLACK LOWE & GRAHAM PLLC, Suite 4800, 701 Fifth Avenue, Seattle, WA, 98104, US

(21) Appl. No.: 10/835,973

(22) Filed: Apr. 30, 2004

Related U.S. Application Data
(60) Provisional application No. 60/466,964, filed on Apr. 30, 2003.

(51) Int. Cl. B26B 3/00

(52) U.S. Cl. 30/280; 30/316

(57) ABSTRACT

A kitchen tool is defined by a cutting blade secured to a handle. In the preferred form, the cutting blade forms a rounded hoop in which the blade has a first edge and a second edge, with the blade edges defining a plane lying orthogonal to that of the hoop. The hoop is preferably substantially open, without additional cutting elements.

### FIELD OF THE INVENTION

This invention relates generally to food preparation tools, particularly including tools for separating the flesh of a fruit from the peel.

### BACKGROUND OF THE INVENTION

Fruits and vegetables are often peeled and pitted prior to cooking or serving. Soft-fleshed fruit such as melons, kiwi, and peaches are often peeled, and vegetables such as tomatoes, bell peppers and zucchini are sometimes seeded and stuffed. These are usually prepared with a spoon, although a spoon is not the optimal tool for the task. Spoons do not have a sharp edge often required to separate a peel, and the edge of the spoon used to cut in such an operation is at an awkward angle with respect to the handle. In addition, because spoons tend to be narrow, the seeding and scooping process can be slow.

Most products that are particularly designed to process fruit either slice, core or create shapes. One example of such a product is the melon baller, which scoops a portion of melon in the shape of a ball. There are a few other items for narrowly tailored processes, such as the avocado slicer, pineapple slicer, apple peeler/slicer, and kiwi scoop. There is a need, however, for a tool that can quickly and easily separate the flesh of a fruit from the peel.

### BRIEF DESCRIPTION OF THE DRAWINGS

The preferred and alternative embodiments of the present invention are described in detail below with reference to the following drawings.

FIG. 1 is a perspective view of a fruit scoop;

FIG. 2 is a perspective view of a partially disassembled fruit scoop;

FIG. 3 is a perspective view of a preferred handle; and

FIG. 4 is a perspective view of a preferred handle plug.

### DETAILED DESCRIPTION OF THE PREFERRED EMBODIMENT

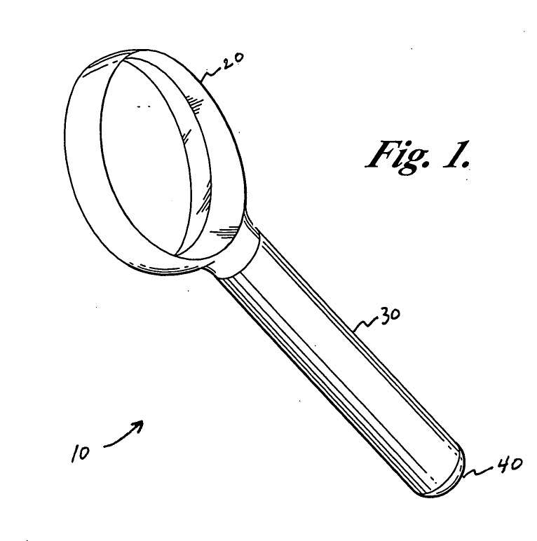

The preferred embodiment of the fruit scoop 10 is shown in FIG. 1. The fruit scoop consists of three parts: the head 20, the handle 30 and the plug 40 at the bottom of the handle. The head and plug are made of reinforced plastic, and the handle is made of stainless steel. Other materials may also be used, however. For example, the head may be made from stainless steel, and the handle may be made of plastic or wood. As another alternative, the entire device may be molded from an integrally molded piece of plastic or other material.

The fruit scoop may be constructed in any size, although three separate sizes are preferred, including a large “melon” size, a medium “red pepper” size, and a small “kiwi” size.

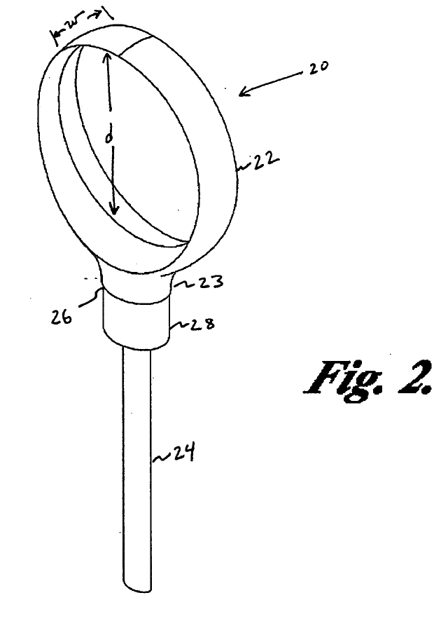

The head 20 is best shown in FIG. 2, where it is illustrated separately in a preferred form in which a separate handle is attached. The head 20 includes a slicing hoop 22 and downwardly-extending shaft 24. The shaft 24 extends generally orthogonally away from the hoop or head 20. The slicing hoop is preferably constructed from plastic, making the slicing edge sharp enough to cut fruit but likely not sharp enough to cut skin. In an alternative embodiment, the hoop is formed from metal to provide a particularly sharp and sturdy blade. The slicing edge is preferably not serrated, but in an alternate form it may include a serrated edge (not shown), either on one side of the hoop or both. The center of the hoop preferably does not include any elements that would interfere with cutting, but rather is an open circle.

The cutting hoop is oriented such that the hoop and handle lie in a first plane. The hoop further has a first edge and a second edge defining a blade having a width w therebetween, with the width w extending in a second plane that is preferably generally orthogonal to the first plane. Preferably the blade is oriented in this fashion along its entire length, but in an alternate embodiment, at a location opposite the handle, a line from the first edge to the second edge lies in a second plane orthogonal to the first plane. In the preferred form, both the first edge and the second edge are sharpened, such that a central portion of the hoop is thicker than either edge and the hoop tapers from the central relatively thick area to either edge.

At the bottom of the hoop 22 is a base 23 that is preferably oval in cross-sectional shape. Below the base 23 is a neck 28 that has a diameter somewhat smaller than the base 23, and which is also oval in cross-sectional shape. The neck forms a shoulder 26 where the neck 28 meets the base 23 of the hoop.

The large version of the fruit scoop 20 has a hoop with a preferred inner diameter d of 85 mm. It is 2.5 mm thick and 13 mm wide at the top w₁, its smallest point. It tapers around to a 20 mm diameter base w₂.

The hoop in the preferred medium size has an inner diameter of 60 mm. It is 2.5 mm thick and 13 mm wide at the top, its smallest point. It tapers around to a 20 mm diameter base, which terminates in a snap fit feature that conforms to the plug. The hoop in the preferred small size has an inner diameter of 40 mm. It is 2.5 mm thick and 13 mm wide at the top, its smallest point. It tapers around to a 20 mm diameter base, which terminates in a snap fit feature that conforms to the plug.

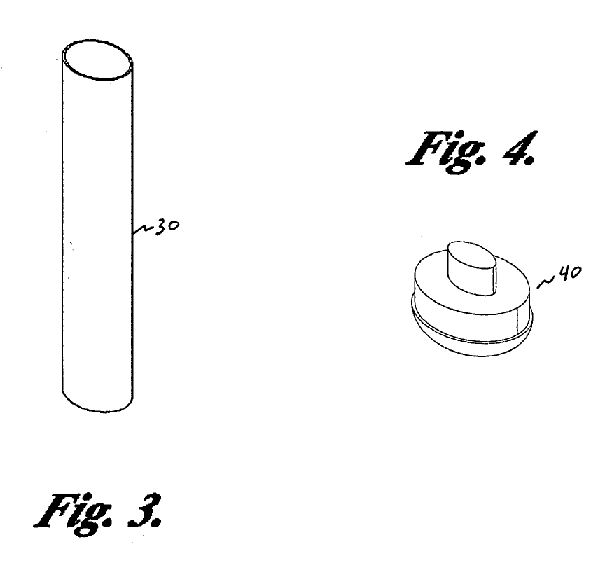

The handle is best shown in FIG. 3, where it is illustrated separately. In cross-sectional shape, the handle 30 is a hollow oval measuring a preferred 17×21 mm in cross section. In the preferred form, the handle is 106 mm long. The handle attaches to the head 20 by sliding it onto the shaft and over the neck 28 until the top edge of the handle abuts the shoulder 26.

A plug 40 (best seen in FIG. 4) attaches the handle permanently to the head shaft, and finishes off the bottom of the handle. It measures 16 mm long, and 17×21 mm in cross section, and has a snap fit feature that conforms to the hoop, so that the plug snap-fits onto the bottom of the shaft to secure the handle to the shaft.

In order to use the fruit scoop, first cut the fruit or vegetable in half and remove any stone. Holding half of the fruit stationary with one hand, use the scoop to slice through flesh, pulling the scoop along the skin to remove the flesh or seeds. Because the slicing hoop has a sharp edge around substantially the entire perimeter, the entire edge can be used for cutting. The hoop is narrower at the top, however, making the top portion of the hoop the best cutting edge.

The fruit scoop makes the preparation of fruits, including seed removal, skin removal, and slicing, easy and quick. It is ideal for removing seeds from melons or other fruits, and also for separating fruits from their peels. When constructed from plastic and stainless steel, it is dishwasher safe and durable. In the preferred form, it has colorful, reinforced plastic scoops for the slicing edge, making it sharp enough to scoop fruit, but not so sharp as to slice through skin. The stainless steel handles used for the handle, however, improves durability.

While the preferred embodiment of the invention has been illustrated and described, as noted above, many changes can be made without departing from the spirit and scope of the invention. Accordingly, the scope of the invention is not limited by the disclosure of the preferred embodiment.

1. A kitchen tool, comprising:
a cutting hoop lying in a first plane, the cutting hoop having a first edge and a second edge defining a blade having a width therebetween, the cutting hoop further having a substantially open center; and
a handle secured to the cutting hoop.

2. The tool of claim 1, wherein the handle is secured to an edge of the cutting hoop and extends orthogonally away from the hoop.

3. The tool of claim 1, wherein the first edge is sharpened.

4. The tool of claim 3, wherein the second edge is sharpened.

5. The tool of claim 1, wherein the cutting hoop further comprises a relatively thick central portion between the first edge and the second edge, and further wherein the hoop is tapered from the central portion to the first edge to define a sharpened first edge.

6. The tool of claim 1, wherein the cutting hoop comprises a first location opposite the handle, and wherein a line extending from the first edge to the second edge along the first location defines a second plane, the second plane being generally orthogonal to the first plane.

7. The tool of claim 1, wherein the cutting hoop further comprises a base, the handle being secured to the base.

8. The tool of claim 1, wherein the cutting hoop and handle are integrally formed from plastic.

9. The tool of claim 1, wherein the first edge is serrated.

10. The tool claim 1, wherein the cutting hoop is substantially circular.
